(19) United States
(12) Patent Application Publication
(10) Pub. No.: US 2008/0104055 A1
(43) Pub. Date: May 1, 2008

(54) RESTAURANT REVIEW SEARCH SYSTEM AND METHOD FOR AUTOMATICALLY PROVIDING LINKS TO RELEVANT REVIEWS OF SELECTED RESTAURANTS BY USE OF THE INTERNET

(75) Inventor: Joseph M. Segel, Bryn Mawr, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DININGINFO LLC, Bryn Mawr, PA (US)

(21) Appl. No.: 11/555,401

(22) Filed: Nov. 1, 2006

(51) Int. Cl. G06F 17/30

(52) U.S. Cl. 707/5

(57) ABSTRACT

A system and method for automatically providing a user with links to relevant reviews of restaurants in a given location by use of the Internet. The system generates a webpage arranged to receive inquiries from a user and utilizes an algorithm to automatically generate a search string of specialized criteria upon receipt of minimal input information from the user in the form of only the name and approximate location of the particular restaurant for which reviews are desired. The search string is automatically provided to a comprehensive search engine on the Internet, which conducts the search and returns the results for automatic display on the webpage.

### FIELD OF THE INVENTION

This invention relates generally to Internet search systems and more particularly to search systems for finding highly relevant reviews of selected restaurants via the Internet.

### BACKGROUND OF THE INVENTION

The Internet has provided persons with the unprecedented ability to search for information regarding all kinds of subjects. While the commercially available search engines, such as Google®, Yahoo®, etc., provide powerful tools to enable persons to find information meeting their particular search criteria, those search engines require the user/searcher to provide well thought out and precise search criteria in order to filter out results that are not particularly pertinent to the information being sought. Entering sparse or overly broad search criteria usually results in too many “hits”, thereby wasting the searcher's time. Narrowing the search criteria is usually necessary to filter out relevant information. But the average person does not have the skill and experience to narrow search criteria most effectively.

One frequent use of the Internet is to search for information regarding restaurants, e.g., restaurant reviews, in order to make an appropriate dining selection. For example, if one conducts a typical Google® search for reviews of the Academy Cafe in Philadelphia, Pa., one might enter the words “Academy Cafe Philadelphia” (without quotes). By using that simple search criteria, one would end up with over 700,000 listings. Even a more sophisticated search using the term “Academy Cafe” (in quotes) followed by the word “Philadelphia” turns up over 500 listings. Because of the inherent efficiency of conventional Internet search engines, relevant listings tend to rise to the top, but oftentimes links to the actual reviews sought are buried in a long list of largely irrelevant results.

Accordingly, a need exists for a system to enable users of the Internet to most effectively search for and generate a highly relevant set of reviews of a selected restaurant. The subject invention addresses that need by automatically generating a sophisticated search string that most effectively filters out results that are not likely to be actual reviews of the selected restaurant. For example, in the case of Academy Cafe, it generates around 100 very relevant listings, rather than a much larger number of listings, most of which are not actually reviews.

### SUMMARY OF THE INVENTION

In accordance with one aspect of this invention there is provided a system for automatically providing a user with links to reviews of restaurants in a given location, e.g., city, metropolitan area, state, nation or other geographic area, by use of the Internet. The system basically comprises webpage generating means and search generating means.

The webpage generating means is arranged for generating a webpage on the user's computer through the Internet. The webpage is arranged to display the names of various restaurants in a selected area. The webpage generating means is also arranged to receive inquiries from users seeking reviews of selected restaurants. The search generating means utilizes an algorithm to generate a search string of predetermined criteria to be used by the system upon receipt of minimal input information from a user. The input information required is only the name and approximate location, e.g., city, of the particular restaurant for which reviews are desired. The search generating means is also arranged to automatically generate the search string to filter out listings that are not likely to be restaurant reviews and for automatically transmitting the search string to at least one comprehensive search engine on the Internet. The search generating means is also arranged for receiving the results of the search from the search engine via the Internet and automatically displaying the results of the search on the webpage.

In accordance with another aspect of this invention there is provided a method for automatically providing a user with reviews of restaurants in a given location by use of the Internet. The method basically entails generating a webpage on the Internet to receive inquiries from users seeking restaurant reviews. The names of various restaurants located in various locations are displayed on the webpage and an algorithm is used to generate a search string of predetermined criteria upon receipt of minimal input information from a user, with that input information being only the name and approximate location, e.g., city, of the particular restaurant for which reviews are desired. The search string is arranged to filter out listings that are not likely to be restaurant reviews. The search string is automatically provided to a comprehensive search engine on the Internet in response to receipt of the input information from the user for the search engine to use to conduct a search of the Internet. The results of the search conducted by the comprehensive search engine are received from the search engine and automatically displayed on the webpage.

In accordance with preferred embodiments of the system and method of invention the search criteria basically comprises: the name of the restaurant, not in quotes, but if the name includes any descriptive word or words all such words are omitted and if the name includes any common word or words or symbols all such words and symbols are omitted, as are any punctuation marks, and if the remaining part of the name consists of more than two words, only the first two words are used; the first word, be it alphabetical or numerical, of the restaurant address or the second word of the restaurant address, except that if the restaurant address includes any type of street name or directional word or abbreviation of such a word all such words and abbreviations are omitted, if the restaurant address includes any common word or words or symbol all such common words and symbols are omitted as are any punctuation marks; the name of the city in which the restaurant is located, except that if the city name includes any common city name prefix, any common word or abbreviation of such word all such words and abbreviations are omitted as are any punctuation marks; the standard abbreviation of the State or Commonwealth in which the restaurant is located; the words “restaurant” or “Cafe” or “bistro” (not in quotes); the words “review” or “rating” or “guide” or “dining” or “dine” (not in quotes); and a method to limit the search to either specific websites or types of websites that are known to include reviews of restaurants in the designated area, which can be either a list of specific URLs, which may be modified with a wildcard character, or an “intitle” statement followed by the first word of the restaurant name, modified in the same manner as set forth above, conjoined with “OR” operators to a series of “include URL” statements, to identify URLs that are known to provide restaurant reviews in the selected geographic region, but which do not include the name of the restaurant in the page title of said reviews, plus a series of self-standing “exclude URL” statements to exclude known websites that contain restaurant listings but not reviews.

### DESCRIPTION OF THE DRAWING

FIG. 1 is a schematic diagram of a system constructed in accordance with the subject invention shown coupled to the Internet;

FIG. 2 is an exemplary webpage generated by the system of this invention for providing an Internet user with the ability to search for restaurants and reviews of restaurants in a particular geographic area and showing that webpage to search for a particular restaurant;

FIG. 3 is an exemplary webpage showing the results of the search conducted by the system and method of this invention for the particular restaurant identified in FIG. 2;

FIG. 4 is the webpage shown in FIG. 2, but showing that webpage to search for all restaurants meeting an exemplary search criteria;

FIG. 5 is an exemplary webpage showing the results of the search conducted by the system and method of this invention for the restaurants meeting the search criteria of FIG. 4;

FIG. 6 is an exemplary webpage showing some highly relevant reviews of the particular restaurant of FIG. 3 found by a search conducted by the Google® search engine and displayed on a webpage of the website generated by the system of this invention.

### DETAILED DESCRIPTION OF THE PREFERRED EMBODIMENT

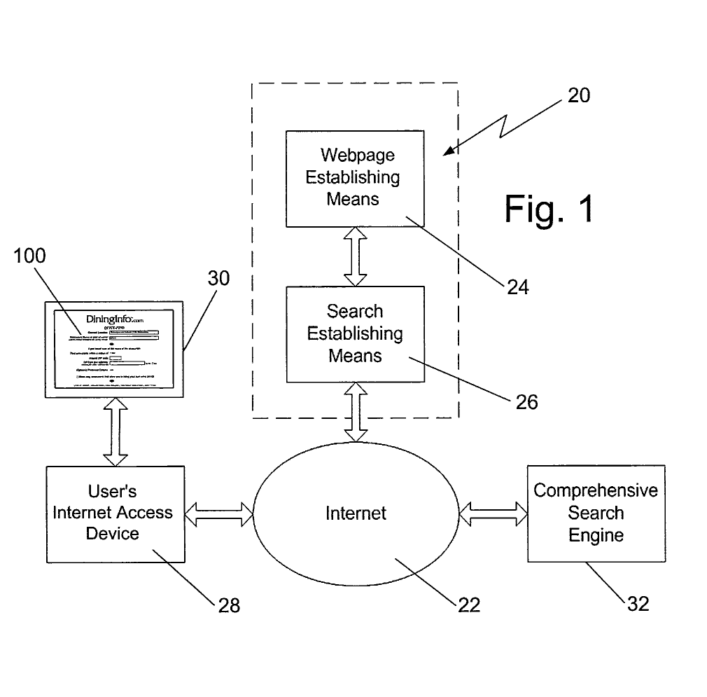

Referring now to the various figures of the drawing wherein like reference characters refer to like parts, there is shown at 20 in FIG. 1 a system for generating a webpage 100 (to be described later) on the Internet 22 where users can go to institute a search for reviews of restaurants in a particular geographic area in response to minimal input information provided by the user. The system 20 basically comprises webpage generating means 24 and search generating means 26. The system 20 is connected to the Internet 22 in any conventional manner, e.g., the system resides on one or more servers (not shown) that are connected to the Internet via any conventional means, e.g., modems, broadband service, T1 lines, etc. Users can access the webpage generated by the system via their own Internet access device 28, e.g., the user's computer, PDA, cellular phone, etc. (not shown), having a video display screen 30. As will be described in considerable detail later the system 20 automatically generates a search string in response to minimal user inputs. The system sends out the search string to a preselected search engine 32 on the Internet, e.g., Google®, Yahoo®, etc., to have that search engine conduct a search of the Internet and to return the results to the system 20, whereupon the results are displayed on a webpage established by the system.

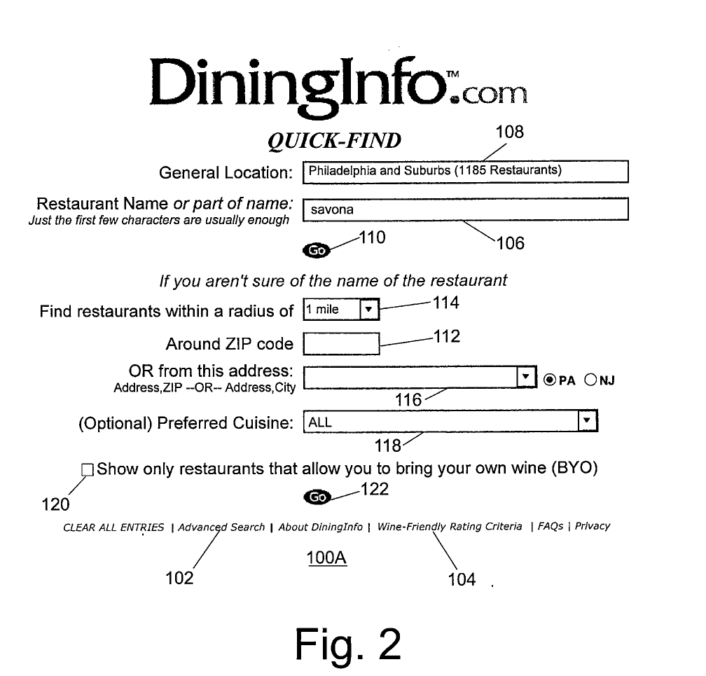

In FIG. 2 there is shown one exemplary webpage 100 on the Internet created and maintained by the webpage generating means 24. It must be pointed out at this juncture that the exemplary webpage 100 is only one of a myriad of webpages that can be generated and maintained by the webpage generating means 24 in accordance with the teachings of this invention. The system 20 is configured so that the webpage 100 enables the user to readily find a desired restaurant within a geographic area. To that end, the webpage 100A is a “Quick-Find” webpage that includes various input boxes into which (or from which) the user of the webpage can enter/select criteria to search for a particular named restaurant in a particular geographic area. The webpage 100 also includes access to an “Advanced Search” webpage (not shown) reached by the link 102 on webpage 100A to enable the user to search or for any restaurants meeting additional search criteria selected by the user. The webpage 100 also provides an option for wine lovers to limit the search to restaurants that allow persons to bring their own wine (BYO).

In order to find a particular restaurant, the webpage 100A includes a box 106 into which the user can insert the name or a portion of the name of the restaurant being sought. A box 108 which may be pre-populated with a city or geographic region, e.g., Philadelphia and Suburbs, or may be in the form of a drop down list from which the user can select a city/geographic region is located above the box 106 for selection by the use. Once those boxes are filled in, all that the user has to do to find the restaurant is to click on the “Go” button 110 appearing on that webpage.

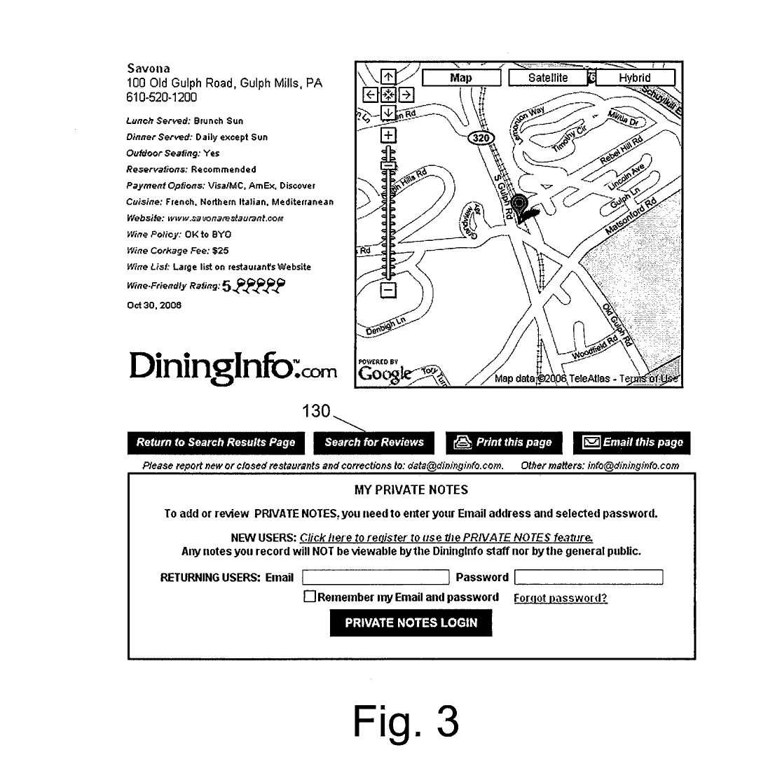

Conducting a search using above described webpage 100 will now be further described. To that end, assuming that the user is looking to find information about the restaurant Savona located in the Philadelphia suburbs, that user enters the name Savona in box 106 and then clicks on the Go button 110, whereupon the system 20 conducts a search of a database of restaurants in the selected region and to display its results. FIG. 3 shows the results of a search for that particular restaurant. As can be seen therein the results of the search produces a webpage having pertinent information about that restaurant, e.g., the restaurant's address, telephone number, type of cuisine, availability of lunch and dinner, reservations information, payment options, etc. In addition information about the restaurants wine policy, e.g., if it is permitted to bring your own (BYO) wine, if there is a corkage fee and if the restaurant has a wine list is also displayed. Further still, the restaurant's “Wine-Friendly Rating” is displayed. The “Wine-Friendly Rating” is represented from one to five icons of a wine glass, with five glass icons representing the highest level of wine friendliness. The webpage also includes a small map showing the location of the restaurant. That map is automatically generated by the system 20 via automatic access to commercial mapping program, e.g., Google® Maps, etc.

To enable the user to find more information about the restaurant, and in particular read reviews of the restaurant, the webpage includes a “Search for Reviews” button 130 (to be described later) for initiating a search of the Internet for pertinent reviews of that restaurant. An example of such a search will be given later.

If the user is not sure of the name of the restaurant, additional input boxes are provided on the webpage 100A to help the user find the restaurant. In particular, the webpage includes a box 112 into which the user inserts the ZIP code for the restaurant and a box 114 into which the user can select from several radii of distances around the particular ZIP code. As an alternative to usage of a ZIP code to find the restaurant, the webpage also includes a box 116 into which the user can insert an address, which can be either the user's address or an address to indicate the approximate location of the restaurant.

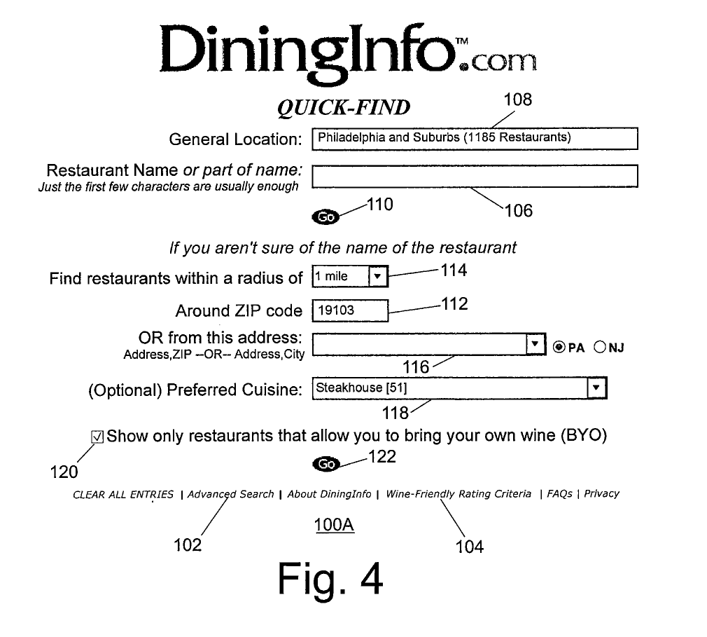

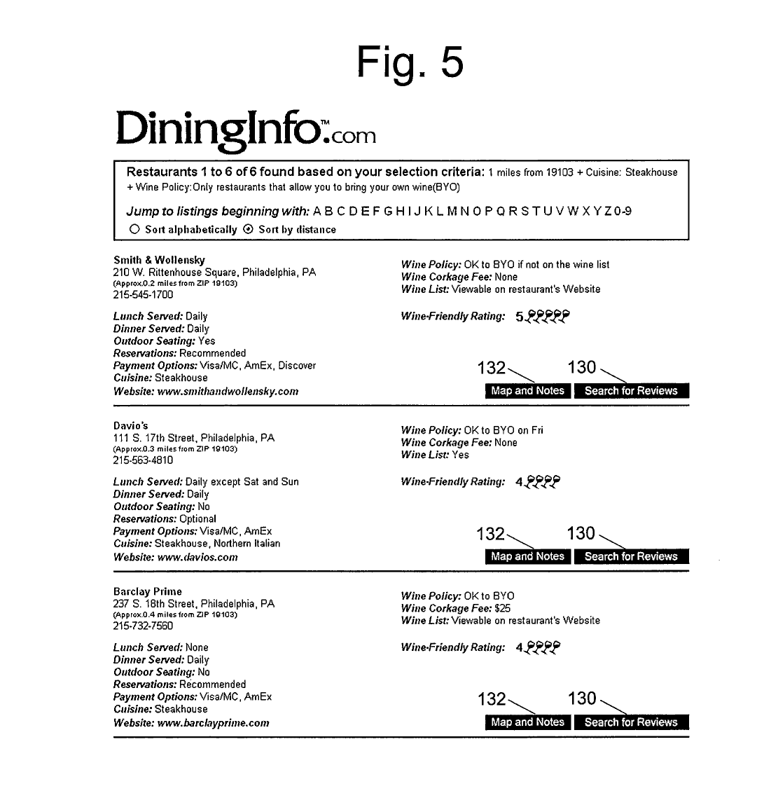

The webpage 100 also enables users to find restaurants that meet various criteria sought by the user. For example, if the user is interested in finding a restaurant that serves a particular cuisine, a box 118 provided on webpage 100A can be used. That box includes a drop down list of many types of cuisines, e.g., French, Chinese, Italian, continental, steakhouse, seafood, etc. In addition, a box 120 is provided to enable the user to find restaurants that allow patrons to bring their own wine. After the pertinent boxes have been filled in and selected, all that the user has to do to find the restaurant or restaurants meeting the search criteria is to click on the Go button 122 appearing on that webpage. For example, assuming that the user is looking to find steakhouse restaurants that permit patrons to bring their own wine and which are located within one mile of the 19103 ZIP code (a portion of downtown Philadelphia), the user selects the one mile entry from the drop down list of box 114, enters the ZIP code 19103 into the box 112, selects the word “steakhouse” from the drop down list in box 118 and checks the box 120 all as shown in FIG. 4. To start the search, the user then clicks on the GO button 122, whereupon the system conducts the search and displays the results on a webpage like shown in FIG. 5. In particular, for this particular search the results include a list of six restaurants (only the first three of which are shown in this illustration) and pertinent information about them. For example, each restaurant's address, telephone number, type of cuisine, availability of lunch and dinner, reservations information, payment options, etc., are displayed. In addition information about its wine policy, e.g., if it is permitted to bring your own (BYO) wine, if there is a corkage fee and if the restaurant has a wine list is also displayed. Further still, the webpage displays the restaurant's “Wine-Friendly Rating”. The webpage also includes a button 130 “Search for Reviews” and a button 132 “Maps and Notes” for each restaurant found. The buttons 130 serve to initiate a search for reviews of that particular restaurant. The buttons 132 each provide a link to a respective webpage with information about the particular restaurant and wherein the information is arranged similar to that shown in FIG. 3. That webpage also includes a button which when selected institutes a search for reviews for that particular restaurant like the button 130 mentioned heretofore.

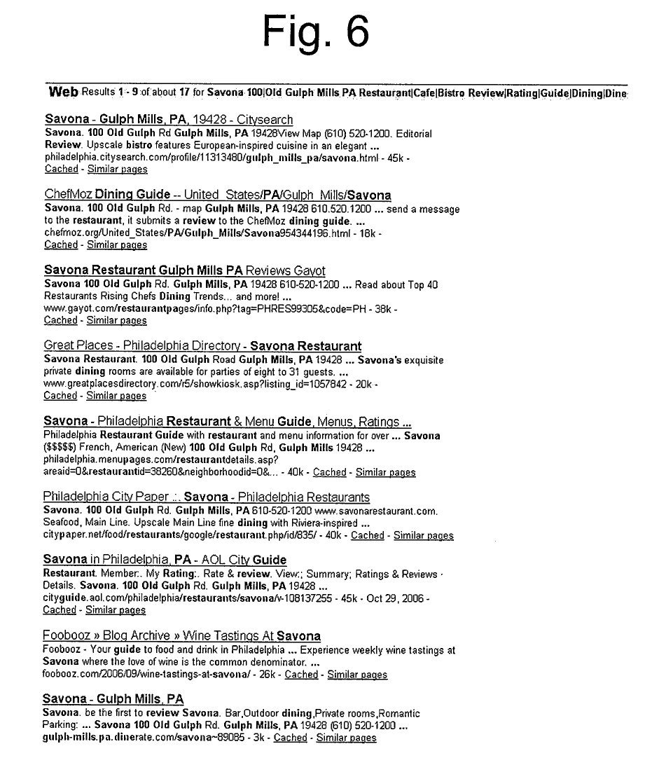

After the search for a particular restaurant or a group of restaurants meeting the particular search criteria of the user has been accomplished, such as described above, a search for pertinent reviews of that restaurant can be readily accomplished by the user of this system by merely clicking on the Search for Reviews button 130. The system will thereupon generate the appropriate search string using the algorithm of the subject invention. For example, if the user wants to find pertinent reviews of the restaurant “Savona,” clicking on the button 130 on the search results webpage shown in FIG. 3 will cause the system to automatically generate the appropriate search string in accordance with the algorithm of this invention (to be described later). The search string is transmitted to any suitable Internet search engine, e.g., Google®, Yahoo®, etc., whereupon the results are returned and displayed for the user as shown in FIG. 6. A portion of the particular search string generated by the system is shown in the top portion of that figure.

As mentioned earlier, in order to conduct a meaningful search of the Internet for reviews for a particular restaurant, the search criteria used should be well thought out and designed to filter out less relevant sites in favor of highly pertinent sites. Unfortunately, the average Internet user is not sufficiently facile with search engines to achieve that end so that the results of his/her search frequently include many hits which prove to be not particularly useful or pertinent. The subject system overcomes that problem by making use of an algorithm which enables the user to find highly pertinent sites (reviews) without having to input more than a minimal amount of input information.

In this regard, the search generating means 26 of system 20 basically comprises a computer (not shown) and associated software (not shown) generating an algorithm for automatically generating a search string to filter out listings related to that restaurant that are not likely to be reviews and for automatically transmitting that search string to a comprehensive search engine, e.g., Google®, Yahoo®, etc., on the Internet. In addition, the search generating means is arranged for receiving the results of the search from the selected search engine and automatically displaying the results of that search on the webpage to be viewed by the user on his/her video screen of his/her Internet access device.

The search string automatically generated by the search generating means 26 will now be described. It comprises: (A) the name of the restaurant, not in quotes, modified in the following manner: (a) if the name includes any descriptive word or words (e.g., Restaurant, Ristorante, Grill, Grille, Cafe, Caffe, Chez, Cucina, Cuisine, Deli, etc) all such words are omitted, (b) if the name includes any common word or words or symbol (e.g., &, A, An, and, at, el, for, from, il, La, Le, of, etc.) all such words and symbols are omitted, (c) if the name includes any punctuation mark or marks (e.g., an apostrophe, hyphen, etc.) all such punctuation marks are omitted, and (d) if the remaining part of the name consists of more than two words, only the first two words are used; (B) the first word, be it alphabetical or numerical, of the restaurant address or the second word of the restaurant address, except that: (a) if the address includes any type of street name or directional word or abbreviation of such a word (e.g., Avenue, Avenues, Ave, Aves, Boulevard, Blvd, Center, Circle, E, East, Highway, Hgwy, Lane, Ln, N, NE, NW, No, North, Pike, Road, Rd, Route, Rte, S, SE, SW, So, South, Square, Street, Streets, St, Sts, SW, W, West, etc) all such words and abbreviations are omitted, (b) if the address includes any common word or words or symbol (e.g., &, A, An, and, at, el, for, from, il, La, Le, of, etc.) all such common words and symbols are omitted, (c) if the address includes any punctuation mark or marks (e.g., apostrophe, hyphen, etc.) all such punctuation marks are omitted; (C) the name of the city in which the restaurant is located, except that: (a) if the city name includes any common city name prefix, common word or abbreviation of such word (e.g., City, E, East, Fort, Ft, Lower, Mount, Mt, N, No, North, S, So, South, Upper, W, West, &, A, An, and, at, el, for, from, il, La, Le, of, etc.) all such words and abbreviations are omitted, (b) if the city name includes any punctuation marks (e.g., apostrophe, hyphen, etc.) such punctuation marks are omitted; (D) the standard abbreviation of the State or Commonwealth in which the restaurant is located; (E) the words “restaurant” or “Cafe” or “bistro” (not in quotes); (F) the words “review” or “rating” or “guide” or “dining” or “dine” (not in quotes); (G) unless the search engine used provides the means to limit the search to a specified long list of URLs, an “intitle” statement followed by the first word of the restaurant name, modified in the same manner as set forth above in A, conjoined with “OR” operators to a series of “include URL” statements, to identify URLs that are known to provide restaurant reviews in the selected geographic region, but which do not include the name of the restaurant in the page title of said reviews, plus a series of self-standing “exclude URL” statements to exclude known websites that contain restaurant listings but not reviews.

It should be pointed out at this juncture that part A of the algorithm doesn't include what would appear to be key descriptive words, like “restaurant” and “Cafe”. Such an omission is purposeful, since it has been discovered that omitting such key descriptive words at that point in the algorithm, but using them in part (E) of the algorithm, results in a search string that is much more likely to result in highly pertinent results by filtering less pertinent webpages. In this regard, because all elements of Step A must be on a webpage for it to be considered relevant, and sometimes a website will omit the descriptive part of the restaurant name or use a synonym for that word, if the restaurant name contains a descriptive word and that word were included in the all required part of the algorithm, a relevant webpage could be missed. But in Step E, only one of the words in each of those steps needs to be somewhere on the webpage for it to be considered relevant. Moreover, all of the excluded words substantially improve the filtering, and if a search engine is used that does not allow for an unlimited list of specific URLs to be searched, the introduction of certain advanced operators (e.g., “include URL,” “exclude URL” and an “intitle” operator) also improves the filtering.

As should be appreciated from the foregoing the system and method of this invention provide a viable means for enabling persons who are not skilled searchers to find highly relevant information about restaurants and wine on the Internet with only a minimal amount of input by such users, e.g., by name or proximity to a certain address.

Without further elaboration the foregoing will so fully illustrate my invention that others may, by applying current or future knowledge, adopt the same for use under various conditions of service.

I claim:

1. A system for automatically providing a user with links to relevant reviews of restaurants in a given location by use of the Internet, said system comprising webpage generating means and search generating means, said webpage generating means being arranged for generating a webpage on the Internet, said webpage displaying names of various restaurants in locations, said webpage generating means also being arranged to receive inquiries from users seeking such restaurant reviews, said search generating means utilizing an algorithm to automatically generate a search string of predetermined criteria to be used by said system upon receipt of minimal input information from a user, said input information being only the name and approximate location of the particular restaurant for which reviews are desired, said search generating means being arranged to automatically generate said search string to filter out listings related to that restaurant that are not likely to be reviews and for automatically transmitting said search string to at least one comprehensive search engine on the Internet, said search generating means being arranged for receiving the results of said search from the at least one search engine and automatically displaying the results of the search on said webpage.

2. The system of claim 1 wherein the location of the restaurant constitutes the metropolitan area of a city.

3. The system of claim 2 wherein said search criteria comprises:
(A) the name of the restaurant, not in quotes, modified in the following manner:
(a) if the name includes any descriptive word or words all such words are automatically omitted,
(b) if the name includes any common word or words or symbol all such words and symbols are automatically omitted,
(c) if the name includes any punctuation mark or marks all such punctuation marks are automatically omitted, and
(d) if the remaining part of the name consists of more than two words, only the first two words are used;
(B) the first word, be it alphabetical or numerical, of the restaurant address or the second word of the restaurant address, except that:
(a) if the address includes any type of street name or directional word or abbreviation of such a word all such words and abbreviations are automatically omitted,
(b) if the address includes any common word or words or symbol all such common words and symbols are automatically omitted,
(c) if the address includes any punctuation mark or marks all such punctuation marks are automatically omitted;
(c) the name of the city in which the restaurant is located, except that:
(a) if the city name includes any common city name prefix, common word or abbreviation of such word all such words and abbreviations are automatically omitted,
(b) if the city name includes any punctuation marks such punctuation marks are automatically omitted;
(D) the standard abbreviation of the State or Commonwealth in which the restaurant is located;
(E) the words “restaurant” or “Cafe” or “bistro” (but not in quotes);
(F) the words “review” or “rating” or “guide” or “dining” or “dine” (but not in quotes);
(G) unless the search engine used provides the means to limit the search to a specified long list of URLs, an “intitle” statement followed by the first word of the restaurant name, modified in the same manner as set forth above, conjoined with “OR” operators to a series of “include URL” statements, to identify URLs that are known to provide restaurant reviews in the selected geographic region, but which do not include the name of the restaurant in the page title of said reviews, plus a series of self-standing “exclude URL” statements to exclude known websites that contain restaurant listings but not reviews.

4. A method for automatically providing a user with links to relevant reviews of restaurants in a given area by use of the Internet, said method comprising:
generating a webpage on the Internet to receive inquiries from users seeking such restaurant reviews,
displaying names of various restaurants located in various cities or metropolitan areas of such cities on said webpage;
utilizing an algorithm for automatically generating a search string of predetermined criteria upon receipt of minimal input information from a user, said input information being only the name and approximate location of the particular restaurant for which reviews are desired, said search string being arranged to filter out listings related to that restaurant that are not likely to be reviews;
receiving from the user said input information;
automatically providing said search string to at least one comprehensive search engine on the Internet;
receiving the results of said search from said search engine; and
automatically displaying the results of said search on said webpage.

5. The method of claim 4 wherein the location of the restaurant constitutes the metropolitan area of a city.

6. The method of claim 5 wherein said search criteria comprises:
(A) the name of the restaurant, not in quotes, modified in the following manner:
(a) if the name includes any descriptive word or words all such words are automatically omitted,
(b) if the name includes any common word or words or symbol all such words and symbols are automatically omitted,
(c) if the name includes any punctuation mark or marks all such punctuation marks are automatically omitted, and
(d) if the remaining part of the name consists of more than two words, only the first two words are used;
(B) the first word, be it alphabetical or numerical, of the restaurant address or the second word of the restaurant address, except that:
(a) if the address includes any type of street name or directional word or abbreviation of such a word all such words and abbreviations are automatically omitted,
(b) if the address includes any common word or words or symbol all such common words and symbols are automatically omitted,
(c) if the address includes any punctuation mark or marks all such punctuation marks are automatically omitted;
(C) the name of the city in which the restaurant is located, except that:
(a) if the city name includes any common city name prefix, common word or abbreviation of such word all such words and abbreviations are automatically omitted,
(b) if the city name includes any punctuation marks such punctuation marks are automatically omitted;
(D) the standard abbreviation of the State or Commonwealth in which the restaurant is located;
(E) the words “restaurant” or “Cafe” or “bistro” (but not in quotes);
(F) the words “review” or “rating” or “guide” or “dining” or “dine” (but not in quotes);
(G) unless the search engine used provides the means to limit the search to a specified long list of URLs, an “intitle” statement followed by the first word of the restaurant name, modified in the same manner as set forth above, conjoined with “OR” operators to a series of “include URL” statements, to identify URLs that are known to provide restaurant reviews in the selected geographic region, but which do not include the name of the restaurant in the page title of said reviews, plus a series of self-standing “exclude URL” statements to exclude known websites that contain restaurant listings but not reviews.
